(19) United States
(12) Patent Application Publication
(10) Pub. No.: US 2011/0265617 A1
(43) Pub. Date: Nov. 3, 2011

(54) METHOD AND SYSTEM FOR CUTTING GLASS

(75) Inventor: Paul M. CHRISTIAN, Flemington, NJ (US)

(73) Assignee: PMC SOFTWARE INC.

(21) Appl. No.: 13/097,761

(22) Filed: Apr. 29, 2011

Related U.S. Application Data
(60) Provisional application No. 61/330,713, filed on May 3, 2010.

(51) Int. Cl. B26D 5/00; B26D 7/27

(52) U.S. Cl. 83/13; 83/75.5

(57) ABSTRACT

A material cutting line system including a cutting table, a material cutter positioned on the table and a control system for controlling the material cutting line such that sheets of material are cut into a plurality of individual workpieces, the control system including a machine readable medium having computer readable instructions thereon for defining a plurality of runs, wherein each run is optimized to minimize the number of sheets of material required to be cut to produce the plurality of individual workpieces, thereby minimizing the amount of resulting waste material from the sheets; identifying the amount of waste material from each sheet to determine the lowest yielding sheets from the plurality of runs; and, grouping the plurality of lowest yielding sheets to form an exception run.

### FIELD OF THE INVENTION

The present invention relates generally to a method and system for cutting material with a CNC machine, and more particularly to a method and system for cutting glass.

### BACKGROUND OF THE INVENTION

Glass cutting lines, including glass cutting tables are known in the art. Typical glass cutting tables are designed to cut generally rectangular pieces of glass into a plurality of individual glass workpieces for subsequent processing and manufacturing. Typical glass cutting lines include a sheet feeding device, a CNC (computer numerical control) cutting machine adapted to work with or on a glass cutting table, further processing devices and a racking device.

FIG. 1 shows a typical prior art glass cutting line, including a sheet feeder 10, a glass cutting table 20, a further processing station in the form of an insulating station 30 and a racking unit 40. In operation, sheets of glass are loaded and moved onto the cutting table. The sheets are then scored and snapped to produce individual glass workpieces, commonly known in the art as lites. The lites are then fed to an insulating line, where they are assembled, according to spacer requirements for a specific job requirements and otherwise processed as need be. Finally, the resulting insulating units (IGUs) are slotted into racks for distribution to further manufacturing steps.

Existing glass cutting lines typically utilize a production control system designed to minimize scrap. Previously, a specific cutting schedule for a production run, or single batch, was prepared in advance by the control system. The production run essentially corresponded to the number of harp racks and associated slots at the sorting station. Basically, older optimization programs were used to determine the optimal cutting schedule for filling the slots of the harp racks with the desired glass work pieces.

The cutting schedule essentially refers to the collection of layouts of the individual glass work pieces on all the glass sheets to be cut for the production run or batch. Following the batch production run, the filled harp racks were moved to the next location in the manufacturing process. The older optimization systems were limited by several problems. First, each system was limited by the number of available slots in the available harp racks. In general, the greater the number of slots the greater the yield since the optimizing program will have a greater number of pieces to select from to maximize product yield. Second, the harp racks generally could not be moved until the entire production run is completed, including the re-cuts at the end of the batch process. Third, the existing last sheet problem increased yield loss, even with re-cuts incorporated into the last sheet. Additionally, the existing older systems do not easily accommodate special pieces not accounted for in the production run.

One such prior art system is disclosed in U.S. Pat. No. 6,879,873 issued Apr. 12, 2005 to Billco Manufacturing Inc. FIG. 2 of this patent, and its related description, shows an optimization of a single sheet of glass from which a number of lites of glass are cut while minimizing waste.

While prior art systems are optimized to minimize wasted material, the order in which sheets of glass is cut and workpieces produced is otherwise unaccounted for and can result in significant delays in processing or shipping the material, for example when an optimization is done to minimize waste across several orders, with different shipping times. Furthermore, prior art systems are unable to properly optimize the timing and order of cuts when a single order requires more than one type or thickness of material. Other systems merely cut the material for a single job at one time and are optimized to produce the fastest production times, with no consideration as to the amount of waste material produced.

It is therefore an object of the invention to provide a novel method and system for glass cutting.

### SUMMARY OF THE INVENTION

In accordance with an aspect there is disclosed a method and system for cutting glass wherein the lowest yielding sheets from a plurality of Runs are grouped together to form a run of lowest yield sheets and are preferably processed and otherwise carried out as the first task in a schedule.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 shows an exemplary glass cutting line system.

FIG. 2 shows an exemplary computer system on which the control system of the invention may be implemented.

FIG. 3 is a flowchart showing instructions on a control system according to the invention.

FIG. 4 is a representative sheet of material from which individual workpieces are to be cut and optimized to minimize waste material.

FIG. 5 is a layout of optimized schedules of runs according to one example herein disclosed.

FIG. 6 is a layout of an exception run according to the example in FIG. 5.

### DETAILED DESCRIPTION OF THE EMBODIMENTS

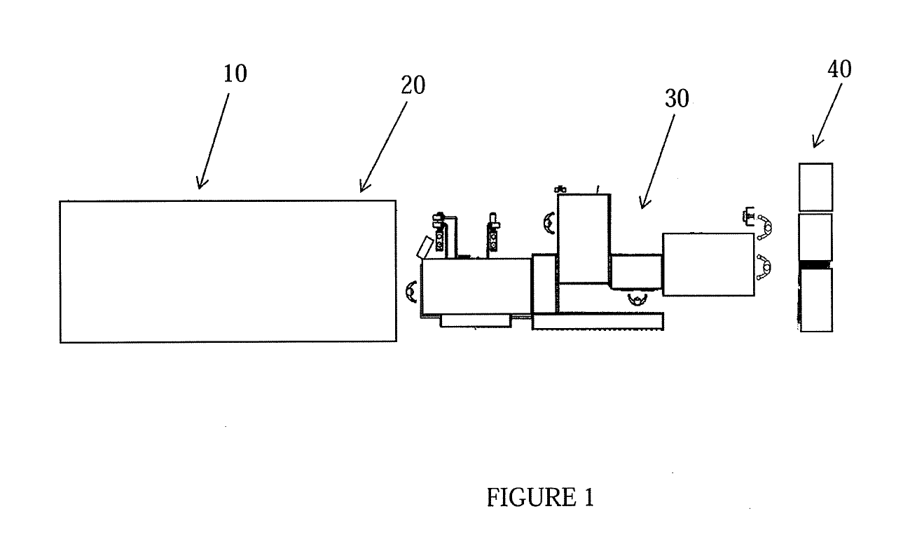

FIG. 1 shows a typical glass cutting line, including a sheet feeder 10, a glass cutting table 20, a further processing station 30 and a racking unit 40. In operation, sheets of glass are loaded and moved onto the cutting table. The sheets are then scored and snapped to produce individual glass workpieces, commonly known in the art as lites. The lites are then fed to the further processing stations where they are assembled and otherwise processed as need be. For example, in the preparation of double paned glass windows where two lites are separated by a determined space, with a vacuum therebetween for insulating purposes, the further processing station may include various spacer devices and attachment tools to form the double paned glass window elements. In this case, the resulting insulating units are slotted into racks for distribution to further manufacturing steps. In this specification, the terms workpieces and lites are used interchangeably. For clarity, a lite is a workpiece of glass material. While the embodiments described herein pertain generally to a glass cutting line, it will be understood by those skilled in the art that the invention is application to cutting lines for other materials as well. In addition, while exemplary post cutting processing steps are herein described, it is understood that these are by way of example only, and various other post processing of the glass lites as would be known to a person skilled in the art are also contemplated by the invention.

The invention provides for an improved control system for operating and otherwise controlling a material cutting line system, such as the glass cutting line system illustrated in FIG. 1. It will be understood by those skilled in the art that the control system may operate a number of different cutting tools dependent on the material being cut. For example, in the case of cutting glass sheets, the cutting tools may include a scorer and a snapper.

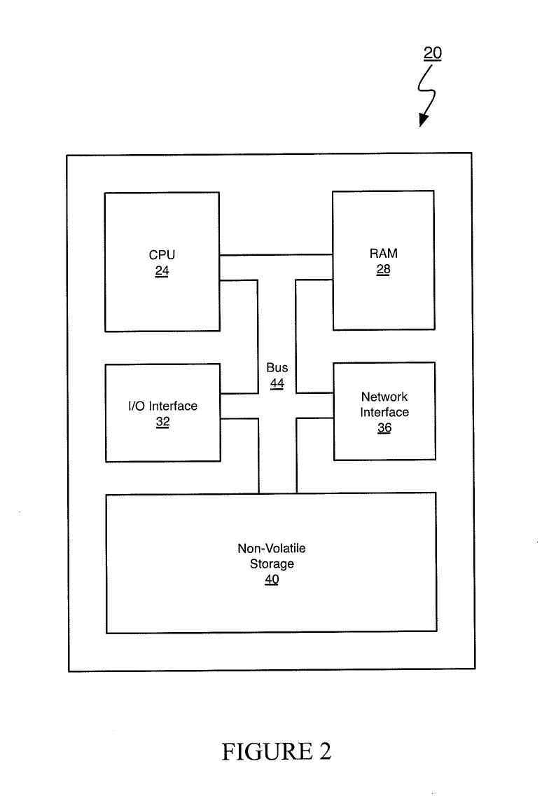

The improvements to the control system of a glass cutting line system as herein described may be implemented in a controller that is preferably a computer system that includes one or more components of the system 10 as herein described. The computer may generally include, as shown in FIG. 2, a number of physical and logical components, including a central processing unit (“CPU”) 24, random access memory (“RAM”) 28, an input/output (“I/O”) interface 32, a network interface 36, non-volatile storage 4, and a local bus 44 enabling the CPU 24 to communicate with the other components. The CPU 24 executes an operating system, and a number of software systems and/or software modules. RAM 28 provides relatively-responsive volatile storage to the CPU 24. The I/O interface 32 allows for input to be received from one or more devices, such as a keyboard, a mouse, etc., and outputs information to output devices, such as a display and/or speakers. The network interface 36 permits communication with other elements of the invention described herein as being in networked communication with each other. Non-volatile storage 4 stores the operating system and programs. During operation of the computer system, the operating system, the programs and the data may be retrieved from the non-volatile storage 4 and placed in RAM 28 to facilitate execution.

In certain embodiments, where the computer system is separate from the CNC machine according to an embodiment of the invention, the CNC machine includes similar hardware and software components as the computer system described above, and preferably includes a separate computer system integral with the CNC machine. The CNC machine forms a part of the glass cutting line as described above.

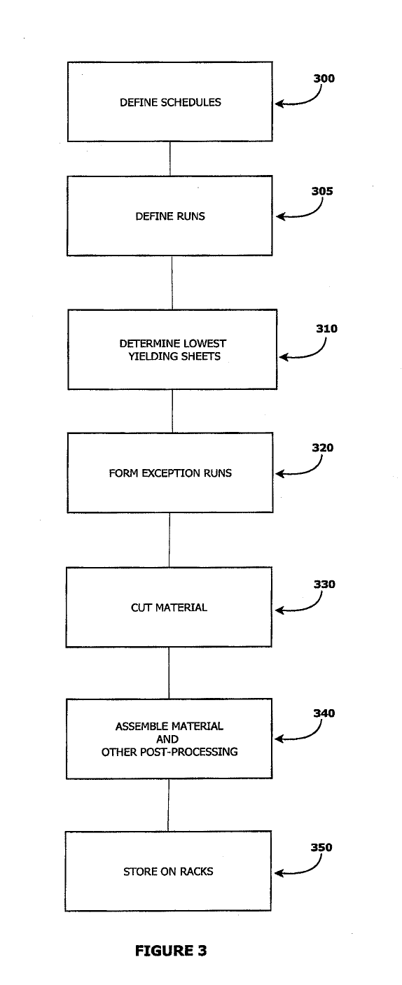

Referring now to FIG. 3, there is shown one embodiment of the method according to the invention for cutting sheets of material into a plurality of individual workpieces, including providing a material cutting line system as herein described. In step 305, a plurality of runs are defined, such that each run is optimized to minimize the number of sheets of material required to be cut to produce the plurality of individual workpieces. thereby minimizing the amount of resulting waste material from said sheets. Optionally, in step 300, a plurality of schedules are defined such that each said schedule includes one or more selected from the group comprising of a predetermined number of sheets, a predetermined type of sheets, a predetermined thickness of sheets, a predetermined material of sheets, and combinations thereof. Each of the plurality of runs in step 305 is preferably defined based on these schedules, such that each run includes sheets of a particular type, thickness and material. In step 310, the amount of waste material from each sheet is identified to determine the lowest yielding sheets from each of the plurality of runs. In step 320, each of the lowest yielding sheets are grouped together to form an exception run. In step 330, each of the sheets of material is cut into a plurality of workpieces according to a determined order of runs. Preferably, the predetermined order includes cutting the exception run as the first run of the day, or in the case of more than one exception runs, cutting each of the exception runs before any of the remaining runs. Preferably, the cutting step 330 includes the step of scoring each of the sheets and the step of snapping each of the sheets along scored lines to complete the cut.

After the cutting step 330, the individual workpieces that have now been cut are preferably grouped and otherwise assembled as required for a particular job, in step 340. In step 350, the now assembled workpieces are stored on a rack until each of the assembled workpieces for a particular job are completed, at which point the final products can be delivered.

Furthermore, the processing of exception lites at the outset allows for these to be ready for further processing as soon as the full runs have been completed. In the exemplary embodiment, the exception lites are stored in a temporary racking unit until the remainder of the lites are ready for processing.

It will be understood by those skilled in the art that the invention may be carried out on a separate computer system as described above, and the data generated therefrom subsequently transferred to the CNC machine, or alternatively and preferably, any one of a computer system, a controller, an optimizer, or similar machines capable of running the optimization and sorting routines as described above may be directly integrated into the CNC machine. In this manner, an operator may observe a proposed optimization and scheduling of the exception runs and accept same prior to beginning a full schedule. The invention provides for optimizing yield and time considerations in scheduling glass cutting runs, whereas prior art devices optimized one of yield or time. Accordingly, the invention provides an improved method and system for cutting glass. The invention relates equally to a computer system for carrying out the method herein described, a CNC machine for carrying out the method and a controller adapted to work with the CNC machine for carrying out the method.

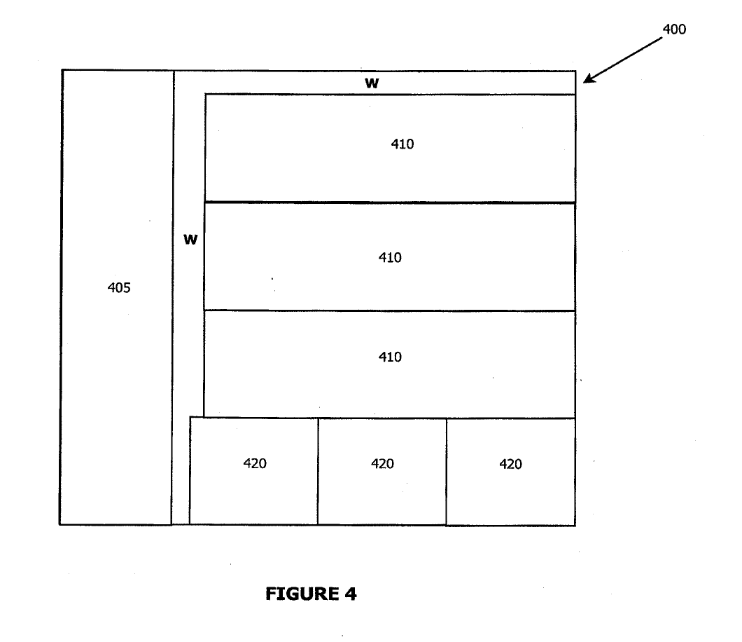

According to one embodiment of the invention, orders for glass workpieces are placed for a number of variously sized shapes (typically rectangular) of glass, also referred to as lites. These orders are completed by cutting the lites from a larger sheet of stock material of a given size. An optimization routine is executed to determine the positioning of the variously sized lites to be cut out of the larger sheets. One such optimization is to minimize the amount of waste material that is residual to each of the individual lites being cut. An optimization of this type is shown in FIG. 4. It is believed that various optimization routines capable of performing the optimization shown in FIG. 4. are known in the art and are therefore not described in further detail herein. According to one example, daily order requirements are split into smaller schedules based on constraints set by, for example, plant size, machine capabilities, amount of post-processing required and/or time required to complete the schedule. These schedules are then further separated into batch runs to group together based on material requirements, such as thickness, color and type of material. In this manner, all required lites to be cut from a particular material thickness, color or type, are cut in one or more batch runs, so as to minimize the amount of time required to change tooling on the material cutter. Once the optimization is carried out, there will be a sheet of stock material in the batch run typically the last sheet to be cut, that includes the highest amount of waste material. This sheet is herein referred to as the lowest yield sheet.

According to the invention, the lowest yielding sheets of each run in a full schedule are taken out of their respective runs and grouped to form a new run, hereinafter referred to as the exception run. Once the lowest yielding sheets have been identified from the optimization process carried out for each batch run, the lites to be cut from the lowest yielding sheets are themselves re-optimized as one or more separate runs. Typically, this would be a single run only, but depending on the number of sheets being cut in a given schedule, there may be more than one exception run. Thus, one or more run of lites derived from the lowest yielding sheets of the initial optimization is prepared. The exception runs are preferably executed as the first scheduled runs to be cut of a given time period, typically the first of the shift.

In the prior art, runs have been limited to a single glass color and thickness as part of the optimization routines. Schedules or batches of runs incorporate the requirements for multiple glass color and thickness combinations. These requirements are then later split into runs. According to the invention, the color and thickness restrictions on the runs are preferably removed and rather, the requirements from the lowest yielding sheets are incorporated into the schedules.

According to the invention, the first schedule of the day generates lites that belong to a number of different batches and are those that would otherwise have been produced from the lowest yielding sheets. These lites are then cut based on the optimization and stored until the remaining lites of the original batch runs of which these are to be a part are cut, following which the now completed run can be further processed, delivered, or otherwise disposed of according to the requirements of the job. In this manner, a combination of high throughput and low waste material may be achieved in that runs requiring little variation, change in tooling, or change in programming of the CNC machine may be scheduled consecutively. The exception lites in those runs do not hinder transition from one run to the next as these have been cut during the exception run.

### Example

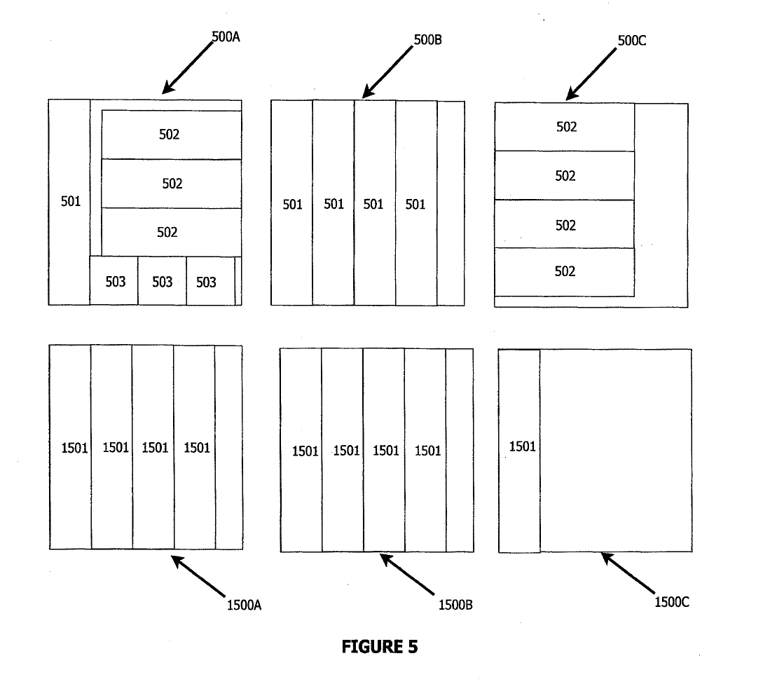

FIG. 5 shows two schedules of glass workpieces, 500A-C and 1500A-C, that have been optimized according to known methods in the art to minimize the amount of waste material resulting from the running each of the schedules independently. As shown, workpieces labeled as 501, 502 and 503 are each of a respective size. According to prior art methods, the sheets 500A, 500B, and 500C would be cut in consecutive runs to complete the first schedule. Following this, sheets 1500A, 1500B and 1500C would be cut in consecutive runs to complete the second schedule.

According to the invention, an optimization routine is carried out on the desired workpieces of the 500 series to arrive at the layout of the sheets 500A, 500B and 500C as shown in FIG. 5. A further optimization routine is carried out on the desired workpieces of the 1500 series to arrive at the layout of the sheets 1500A, 1500B, and 1500C. In practice, a wider variety of shapes and workpieces sizes will be used, but for illustrative purposes and to aid in the understanding of the invention, a simplified example has been used.

From these optimization routines, the amount of waste material from each sheet is determined, for example, by way of subtracting the area used to cut workpieces from the overall area of the sheet, and identifying the lowest yielding sheets from each run. In this example, sheet 500C is the lowest yielding sheet of the first run and sheet 1500C is the lowest yielding sheet of the second run.

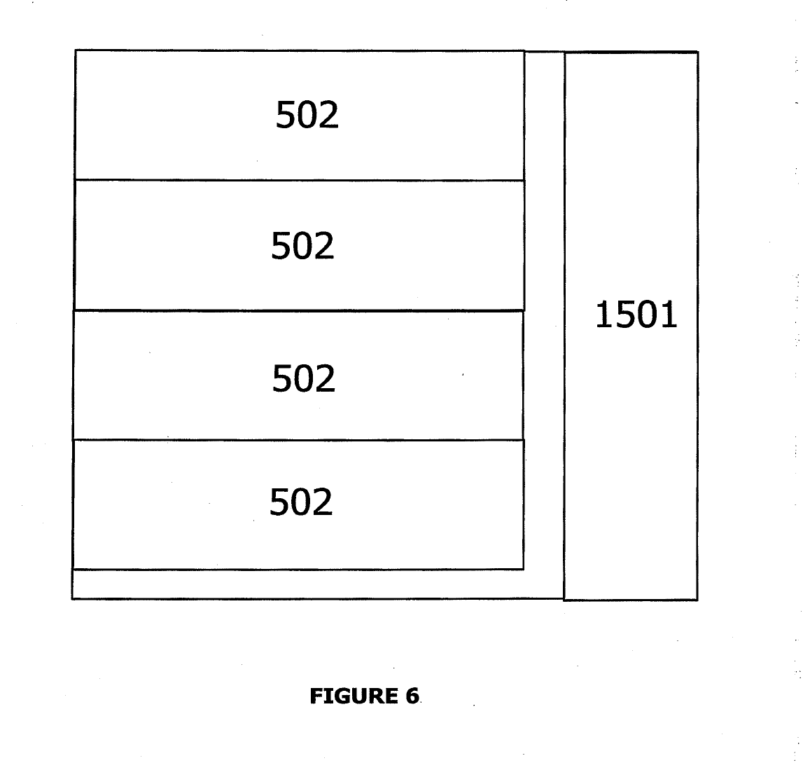

Each of the lowest yielding sheets are then grouped to form an exception run, and a further optimization routing is carried out to minimize waste in this exception run. Accordingly, the workpieces intended to be cut from sheets 500C and 1500C are optimized, for example as shown in FIG. 6. Thus, the optimization results in an exception run which would be that cut from the sheet shown in FIG. 6 to produce the workpieces 502 and 1501 shown in FIG. 6.

Preferably then, the sheet of FIG. 6 is cut as the first run of the period, for example the day, followed by each of the remaining sheets in the schedules of FIG. 5. Once the sheet in FIG. 6 is cut, the workpieces 502 are stored on one rack until each of the remaining workpieces of the 500 series of FIG. 5 are cut and ready to be further processed, assembled and/or transported. Similarly, the workpiece 1501 is stored on a separate rack until each of the remaining workpieces of the 1500 series of FIG. 5 are cut and ready to be further processed and/or transported.

Various alternatives to prior art glass cutting methods and systems are now made possible by way of this invention. For example, exception runs as herein defined, could be used to combine cuts from a different thickness of material in each of the regular schedule of runs. In the example of FIG. 5, it is possible that sheet 500C is of a different material or thickness than sheets 500A and 500B. Whereas, sheets 1500A, 1500B and 1500C are all of the same material as sheet 500C. Thus, the exception run also takes advantage of optimizing schedules of runs so that lites to be cut from a particular type, thickness or property of material form the exception runs, and are then optimized so that the materials that differ are also optimized to reduce waste across all of the schedules of a given time period, for example a day.

It will further be appreciated by one skilled in the art that the invention may be implemented on a variety of types of material cutting machines, and more specifically, glass cutting machine systems. Further details of these systems are known in the art and not described in further detail herein.

Various other modifications, alternatives and variations of the invention will be apparent in view of the above disclosure. It will be understood by those skilled in the art that the invention is not limited to the above disclosure and that such modifications, alternative and variations are within the scope of the invention.

1. A material cutting line system comprising:
a cutting table;
a material cutter positioned on said table;
a control system for controlling the system such that sheets of material are cut into a plurality of individual workpieces, said control system comprising a machine readable medium having computer readable instructions thereon for:
defining a plurality of runs, wherein each run is optimized to minimize the number of sheets of material required to be cut to produce said plurality of individual workpieces, thereby minimizing the amount of resulting waste material from said sheets;
identifying the amount of waste material from each sheet to determine the lowest yielding sheets from said plurality of runs;
grouping said plurality of lowest yielding sheets to form an exception run.

2. A material cutting line system according to claim 1, wherein said grouping further includes optimizing such that the workpieces to be cut from said plurality of lowest yielding sheets are optimized to minimize the number of sheets of material required to be cut in said exception run.

3. A material cutting line system according to claim 2, wherein said exception run is cut before each of said plurality of runs.

4. A material cutting line system according to claim 1, wherein said control system further includes instructions for defining a plurality of schedules; each said schedule including one or more selected from the group comprising: a predetermined number of sheets, a predetermined type of sheets, a predetermined thickness of sheets, a predetermined material of sheets, and combinations thereof.

5. A material cutting line system according to claim 4, wherein said control system further includes instructions to define said plurality of runs based on said schedules, such that each run includes sheets of a particular type, thickness and material.

6. A material cutting line system according to claim 1, wherein said material is glass.

7. A material cutting line system according to claim 1, wherein said material cutter comprises a material scoring element and a material snapping element.

8. A material cutting line system according to claim 1, further comprising a material processing station for processing said workpieces in accordance with an intended job requirement.

9. A material cutting line system according to claim 8, further comprising a racking unit for temporarily storing said workpieces.

10. A method for cutting sheets of material into a plurality of workpieces comprising:
providing a material cutting line system including a cutting table, a material cutter and a control system;
defining a plurality of runs, wherein each run is optimized to minimize the number of sheets of material required to be cut to produce said plurality of individual workpieces, thereby minimizing the amount of resulting waste material from said sheets;
identifying the amount of waste material from each sheet to determine the lowest yielding sheets from said plurality of runs;
grouping said plurality of lowest yielding sheets to form an exception run; and,
cutting said sheets of material into said plurality of workpieces according to a determined order of runs.

11. A method according to claim 10, wherein said grouping further includes optimizing such that the workpieces to be cut from said plurality of lowest yielding sheets are optimized to minimize the number of sheets of material required to be cut in said exception run.

12. A method according to claim 10, further comprising:
defining a plurality of schedules; each said schedule including one or more selected from the group comprising: a predetermined number of sheets, a predetermined type of sheets, a predetermined thickness of sheets, a predetermined material of sheets, and combinations thereof.

13. A method according to claim 12, further comprising:
defining said plurality of runs based on said schedules, such that each run includes sheets of a particular type, thickness and material.

14. A method according to claim 10, wherein said material is glass.

15. A method according to claim 10, where said step of cutting comprises scoring said sheets and snapping said sheets.

16. A method according to claim 10, further comprising after said cutting step, grouping and otherwise assembling said workpieces as required for a particular job.

17. A method according to claim 16, further comprising storing cut grouped and otherwise assembled workpieces on a rack for delivery.
